(19) United States
(12) Patent Application Publication
(10) Pub. No.: US 2025/0201196 A1
(43) Pub. Date: Jun. 19, 2025

(54) DISPLAY DEVICE

(71) Applicant: WUHAN CHINA STAR OPTOELECTRONICS SEMICONDUCTOR DISPLAY TECHNOLOGY CO., LTD., Wuhan, Hubei (CN)

(72) Inventors: Jiujian HAN, Wuhan, Hubei (CN); Junjie FU, Wuhan, Hubei (CN); Pengfei LIANG, Wuhan, Hubei (CN); Youwei XIAO, Wuhan, Hubei (CN)

(21) Appl. No.: 17/790,395

(22) PCT Filed: May 23, 2022
(86) PCT No.: PCT/CN2022/094404

§ 371 Date: Feb. 26, 2025

(30) Foreign Application Priority Data
Apr. 29, 2022 (CN) 202210471952.6

(51) Int. Cl. G09G 3/3258

(52) U.S. Cl. CPC G09G 3/3258; G09G 2300/043; G09G 2310/08; G09G 2320/0233; G09G 2320/0666; G09G 2330/021

(57) ABSTRACT

Provided is a display device (100). The display device (100) includes a display panel (10), a driving chip (20), a first signal transmission line (12), and a compensation line (14). In a display stage, a first terminal (a) of the driving chip (20) outputs an initial power reference voltage (ELVSS) and transmits it to a cathode (B) of a light-emitting device (D) through the first signal transmission line (12), a second terminal (b) outputs an initial anode reset voltage (V0) to an anode (A) of the light-emitting device (D), and the compensation line (14) transmits an anode reset voltage (VI) that changes synchronously with the initial power reference voltage (ELVSS) to any position of the first signal transmission line (12).

### TECHNICAL FIELD

The present application relates to a field of display technology, in particular, to a display device.

### BACKGROUND

Organic light emitting display (OLED), as a new generation of display technology, has higher contrast, faster response speed, and wider viewing angle. At present, OLED has been widely used in a field of high-performance display. Each pixel in the OLED comprises a pixel driving circuit to drive the pixel to emit light normally. As shown in FIG. 1, the pixel driving circuit 101 in the related art has a structure of seven thin film transistors and one storage capacitor (7T1C). While pixel driving circuit 101 operates, power voltage ELVDD and initial power reference voltage ELVSS are input to a first input end of a driving thin film transistor Td and a cathode B of a light-emitting device D, respectively.

In order to improve display uniformity, an anode A of the light-emitting device D is usually reset so that an initial voltage difference between two poles of the light-emitting device D is constant. However, due to transmission loss and other reasons, an initial power reference voltage ELVSS will change, resulting in a change of the initial voltage difference between the two poles of the light-emitting device D, which will change brightness and chroma of a display screen and reduce yield.

### SUMMARY OF THE DISCLOSURE

### Technical Problem

The present application provides a display device to solve a technical problem that a change of voltage value of an initial power reference voltage in the prior art leads to brightness and chroma of a display screen to change and a reduction of a yield of product.

### THE SOLUTION TO THE PROBLEM

### Technical Solution

The present application provides a display device, comprising:
a display panel, the display panel comprising a plurality of light-emitting devices;
a driving chip, wherein the driving chip has a first terminal and a second terminal; in a display stage, the first terminal outputs an initial power reference voltage to cathodes of the light-emitting devices, and the second terminal outputs an initial anode reset voltage to anodes of the light-emitting devices;
a first signal transmission line, arranged in the display panel and connected with the second terminal, wherein the first signal transmission line transmits the initial anode reset voltage in the display stage; and
a compensation line, wherein the compensation line is connected to any position of the first signal transmission line; and in the display stage, the compensation line transmits an anode reset voltage that changes synchronously with the initial power reference voltage.

Alternatively, in some embodiments of the present application, the driving chip comprises a voltage follower, and the voltage follower comprises an input resistor and a feedback resistance;
wherein a positive input end of the voltage follower receives the initial power reference voltage, a negative input end of the voltage follower, one end of the input resistor, and one end of the feedback resistor are connected together, another end of the input resistor is grounded, another end of the feedback resistance is connected with an output end of the voltage follower, and the output end of the voltage follower is connected with the second terminal, the initial anode reset voltage changes synchronously with the initial power reference voltage.

Alternatively, in some embodiments of the present application, a resistance value of the input resistor and a resistance value of the feedback resistance are equal.

Alternatively, in some embodiments of the present application, the display panel has a first end and a second end arranged corresponding to each other, the driving chip is arranged at the first end, the display device comprises at least one first signal transmission line and at least one second signal transmission line, and both the first signal transmission line and the second signal transmission line extend from the first end to the second end, the second signal transmission line is connected with the first terminal, and in the display stage, the second signal transmission line transmits the initial power reference voltage;
wherein the driving chip further has a feedback terminal and a compensation terminal, the second signal transmission line is provided with a detection point, the first signal transmission line is provided with a compensation point corresponding to the detection point, the feedback terminal is connected with the detection point, and the compensation terminal is connected with the compensation point through the compensation line.

Alternatively, in some embodiments of the present application, the first signal transmission line and the second signal transmission line are arranged in different layers, and the first signal transmission line and the second signal transmission line are overlapping in a direction perpendicular to a light-emitting surface of the display panel.

Alternatively, in some embodiments of the present application, the display panel comprises a display area and a non-display area connected with the display area, and the first signal transmission line and the second signal transmission line are located in the non-display area;
wherein the second signal transmission line is provided with a plurality of detection points, the first signal transmission line is provided with a plurality of compensation points, and the detection points and the compensation points are arranged in a one-to-one correspondence.

Alternatively, in some embodiments of the present application, the display panel comprises two first signal transmission lines and two second signal transmission lines, the two first signal transmission lines are respectively located in the non-display area on both sides of the display area in the display panel, and the two second signal transmission lines are respectively located in the non-display area on the both sides of the display area in the display panel;
wherein each of the two second transmission lines is provided with the plurality of detection points arranged at equal intervals, and the detection points located on the two second signal transmission lines are arranged axisymmetrically.

Alternatively, in some embodiments of the present application, the second signal transmission line is provided with M detection points, and the first signal transmission line is provided with M first compensation points and N second compensation points; along a direction from the first end to the second end, the M detection points and the M first compensation points are arranged in a one-to-one correspondence, wherein M is an integer greater than or equal to 2, and Nis an integer greater than or equal to 1;
wherein at least one of the second compensation points is arranged between two adjacent ones of the first compensation points, and an anode reset voltage corresponding to each of the second compensation points is obtained by interpolating anode reset voltages corresponding to two adjacent ones of the first compensation points.

Alternatively, in some embodiments of the present application, the detection point is located at a position of the second signal transmission line away from the driving chip.

Alternatively, in some embodiments of the present application, the display device further comprises a test line, and the feedback terminal is connected with the detection point through the test line.

Alternatively, in some embodiments of the present application, the driving chip comprises at least one voltage follower, and the voltage follower comprises an input resistor and a feedback resistor;
a positive input end of the voltage follower is connected with the detection point; a negative input end of the voltage follower, one end of the input resistor, and one end of the feedback resistance are connected together; another end of the input resistor is grounded; another end of the feedback resistance is connected with an output end of the voltage follower; and the output end of the voltage follower is connected with the compensation point through the compensation line.

Alternatively, in some embodiments of the present application, a resistance value of the input resistor and a resistance value of the feedback resistance are equal.

Alternatively, in some embodiments of the present application, the display device further comprises at least one voltage follower, the voltage follower is arranged outside the driving chip, and the voltage follower comprises an input resistor and a feedback resistance;
a positive input end of the voltage follower is connected with the detection point; a negative input end of the voltage follower, one end of the input resistor, and one end of the feedback resistance are connected together; another end of the input resistor is grounded; another end of the feedback resistance is connected with an output end of the voltage follower; and the output end of the voltage follower is connected with the compensation point through the compensation line.

Alternatively, in some embodiments of the present application, a resistance value of the input resistor and a resistance value of the feedback resistance are equal.

Alternatively, in some embodiments of the present application, the display device further comprises a circuit board, the circuit board is connected with the driving chip, and the voltage follower is integrally arranged on the circuit board.

Alternatively, in some embodiments of the present application, the display device further comprises a first computing unit and a second computing unit, the first computing unit is connected with the detection point and receives the initial power reference voltage, the first computing unit calculates a difference value between the initial power reference voltage and a detection point voltage, the second computing unit receives the initial anode reset voltage and the difference value, and the anode reset voltage is obtained by adding the difference value to the initial anode reset voltage.

Alternatively, in some embodiments of the present application, the first computing unit and the second computing unit are arranged inside the driving chip.

Alternatively, in some embodiments of the present application, the driving chip further comprises a plurality of third terminals, and in the display stage, the plurality of third terminals output at least one gray-scale voltage to the display panel;
when the gray-scale voltage is less than or equal to a preset voltage, the compensation line transmits the anode reset voltage that changes synchronously with the initial power reference voltage.

Alternatively, in some embodiments of the present application, an amount of change in a voltage value of the anode reset voltage is equal to an amount of change in a voltage value of the initial power reference voltage.

The present application further provides a display device, comprising:
a display panel, the display panel comprising a plurality of light-emitting devices;
a driving chip, wherein the driving chip has a first terminal and a second terminal; in a display stage, the first terminal outputs an initial power reference voltage to cathodes of the light-emitting devices, and the second terminal outputs an initial anode reset voltage to anodes of the light-emitting devices;
a first signal transmission line, arranged in the display panel and connected with the second terminal, wherein the first signal transmission line transmits the initial anode reset voltage in the display stage, and the first signal transmission line is provided with a compensation point;
a second signal transmission line, arranged in the display panel and connected with the first terminal; wherein in the display stage, the second signal transmission line transmits the initial power reference voltage, and the second signal transmission line is provided with a detection point corresponding to the compensation point;
a test line, the test line connected with the detection point;
a compensation line, wherein the compensation line is connected with the compensation point, and in the display stage, the compensation line transmits an anode reset voltage that changes synchronously with the initial power reference voltage; and
a voltage follower, the voltage follower comprising an input resistor and a feedback resistor; a positive input end of the voltage follower is connected with the detection point through the test line; a negative input end of the voltage follower, one end of the input resistor, and one end of the feedback resistance are connected together; another end of the input resistor is grounded; another end of the feedback resistance is connected with an output end of the voltage follower; and the output end of the voltage follower is connected with the compensation point through the compensation line.

### BENEFICIAL EFFECT OF THE DISCLOSURE

### Beneficial Effect

The present application discloses a display device. The display device comprises a display panel, a first signal transmission line, and a compensation line. Wherein the display panel comprises a plurality of light-emitting devices. In a display stage, a first terminal of the driving chip outputs an initial power reference voltage and transmits the initial power reference voltage to cathodes of the light-emitting devices through a first signal transmission line, a second terminal outputs an initial anode reset voltage to the anodes of the light-emitting devices, and the compensation line is configured to transmit an anode reset voltage that changes synchronously with the initial power reference voltage to any position of the first signal transmission line. By adding the compensation line in the display device, the compensation line can output the anode reset voltage that changes synchronously with the initial power reference voltage to the first signal transmission line, so as to reduce the fluctuation amplitude of the voltage difference between the anode and the cathode of each light-emitting device, reduce the change of the brightness and chroma of the display surface, and improve the display quality of the display panel and improve the yield of the products.

### BRIEF DESCRIPTION OF THE DRAWINGS

### Description of the Drawings

In order to explain the technical solutions in the embodiments of the present application more clearly, the following will briefly introduce the drawings needed in the description of the embodiments. Obviously, the drawings in the following description are only some embodiments of the present application. For those skilled in the art, other drawings can be obtained based on these drawings without creative work.

FIG. 1 is a schematic structural diagram of a pixel driving circuit in a related art provided by the present application.

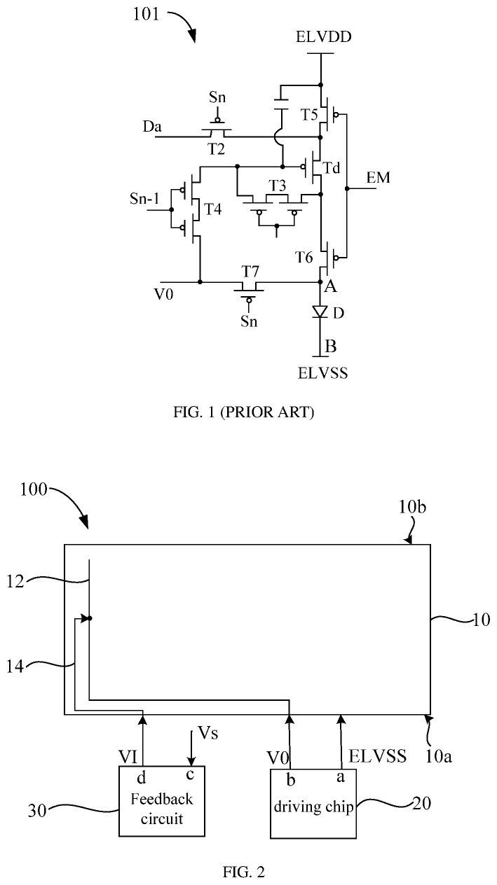

FIG. 2 is a first schematic structural diagram of a display device provided by the present application.

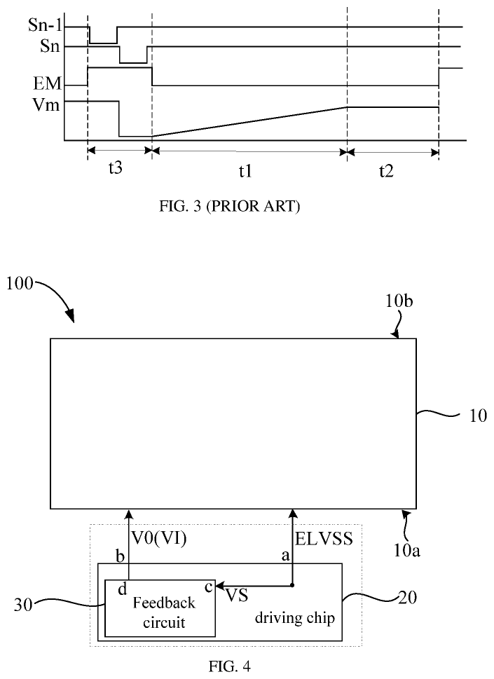

FIG. 3 is a signal timing diagram of the pixel driving circuit shown in FIG. 1 provided by the present application.

FIG. 4 is a second schematic structural diagram of the display device provided by the present application.

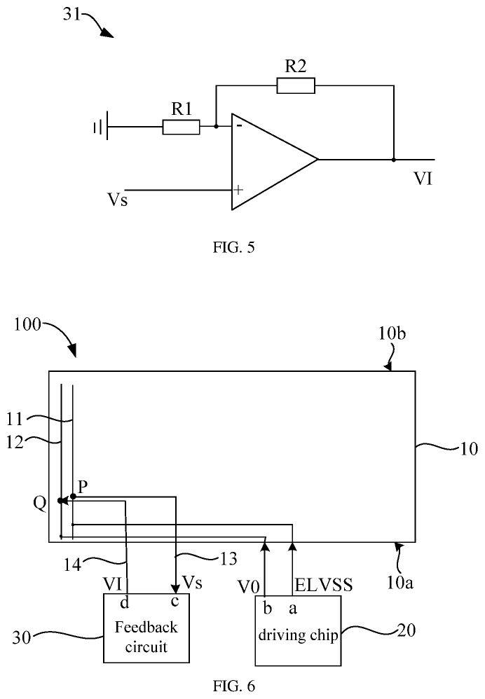

FIG. 5 is a schematic structural diagram of a voltage follower provided by the present application.

FIG. 6 is a third schematic structural diagram of the display device provided by the present application.

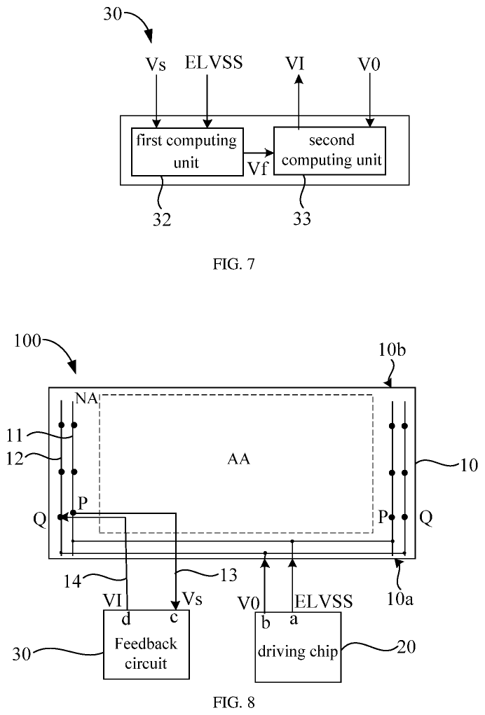

FIG. 7 is a schematic structural diagram of a feedback circuit provided by the present application.

FIG. 8 is a fourth schematic structural diagram of the display device provided by the present application.

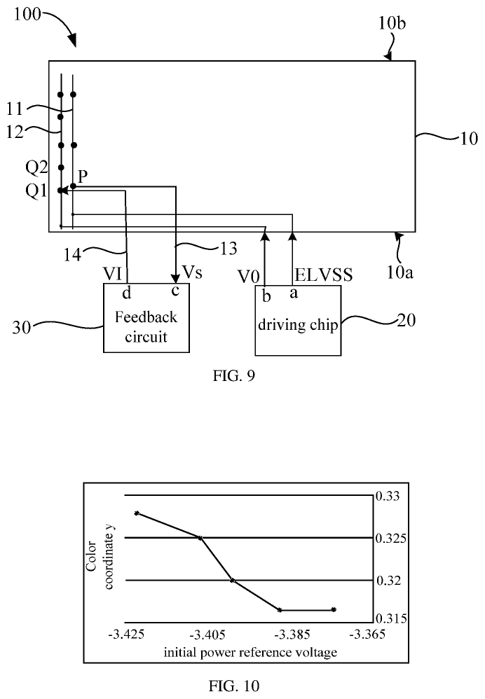

FIG. 9 is a fifth schematic structural diagram of the display device provided by the present application.

FIG. 10 is a schematic diagram of a relationship between an initial power reference voltage and a color coordinate y provided by the present application.

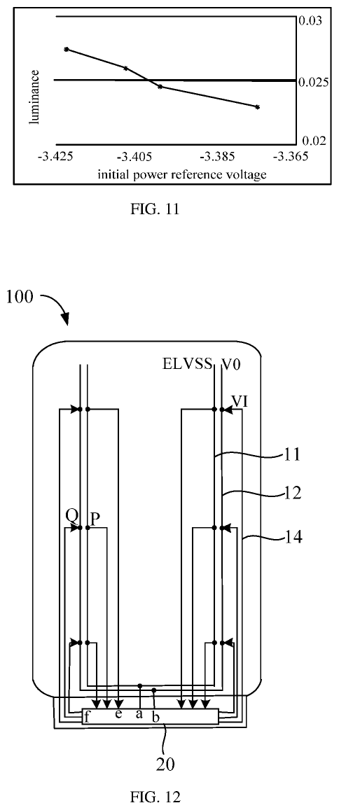

FIG. 11 is a schematic diagram of a relationship between the initial power reference voltage and a luminous brightness provided by the present application.

FIG. 12 is a sixth schematic structural diagram of the display device provided by the present application.

### EMBODIMENTS OF THE DISCLOSURE

### Embodiments of the Present Disclosure

In the following, the technical scheme in the embodiment of the present application will be described clearly and completely in combination with the drawings. Obviously, the described embodiments are only a part of the embodiments of the present application, rather than all the embodiments. Based on the embodiments of the present application, all other embodiments obtained by those skilled in the art without creative work fall within the protection scope of the present application.

In the description of the present application, it should be understood that the terms “first” and “second” are only used for descriptive purposes and cannot be understood as indicating or implying relative importance or implicitly indicating the number of indicated technical features. Thus, the features defining “first” and “second” may explicitly or implicitly comprise one or more of the features. Therefore, it cannot be understood as a limitation on the present application.

The present application provides a display device described in detail below. It should be noted that the order of description of the following embodiments does not limit the preferred order of the embodiments of the present application.

Please refer to FIG. 1 and FIG. 2 at a same time. FIG. 1 is a schematic structural diagram of a pixel driving circuit in a related technology provided by the present application. FIG. 2 is a first schematic structural diagram of a display device provided by the present application. In the embodiments of the present application, the display device 100 comprises a display panel 10, a driving chip 20, a first signal transmission line 12, and a compensation line 14. The display panel 10 comprises a plurality of light emitting devices D. The driving chip 20 has a first terminal a and a second terminal b. In a display stage, the first terminal a outputs an initial power reference voltage ELVSS to cathodes B of the light-emitting devices D. The second terminal b outputs an initial anode reset voltage V0 to anodes A of the light-emitting devices D. The first signal transmission line 12 is arranged in the display panel 10 and is connected with the second terminal b. The first signal transmission line 12 is transmits the initial anode reset voltage V0 in the display stage. The compensation line 14 is connected to any position of the first signal transmission line 12. In the display stage, the compensation line 14 transmits an anode reset voltage VI that changes synchronously with the initial power reference voltage ELVSS.

Please refer to FIG. 3. FIG. 3 is a signal timing diagram of the pixel driving circuit shown in FIG. 1 provided by the present application. Wherein a driving timing of the pixel driving circuit 101 comprises a reset stage and a threshold voltage compensation stage t3, a charging stage t1, and a light-emitting stage t2.

In the reset stage and the threshold voltage compensation stage t3, the (n−1)th stage scanning signal S(n−1) is at a low potential, a fourth transistor T4 is turned on, and a gate electrode of a driving transistor Td is reset to the initial anode reset voltage V0. Then, an n^{th} stage scanning signal Sn is at a low potential, a second transistor T2, a third transistor T3, and a seventh transistor T7 are turned on, and the anode A of the light-emitting device D is reset to the initial anode reset voltage V0. Wherein, a principle of threshold voltage compensation is a technology well known to those skilled in the art and will not be repeated here.

In the charging stage t1, an enable signal EM is at a low potential, and a fifth transistor T5 and a sixth transistor T6 are turned on. At this time, a power voltage ELVDD start charging the anode A of the light-emitting device D. When a potential of the anode A is charged to a target potential (ELVSS+Vth_OLED), charging stops. Wherein the Vth_OLED is a lighting voltage of the light-emitting device D. Since the anode A of the light-emitting device D has been reset to the initial anode reset voltage V0 before charging, an actual anode charging potential difference is (ELVSS+Vth_OLED-V0).

In the light-emitting stage t2, the enable signal EM remains at a low potential because the potential of the anode A is charged to ELVSS+Vth_OLED, meeting a lighting condition of the light-emitting device D, the light-emitting device D starts emitting light.

Wherein a display time of each frame is constant because a time of the reset stage and the threshold voltage compensation stage t3 is fixed, therefore, a charging time of the charging stage t1 will be a main factor affecting a luminous time. Driven by a same gray-scale voltage Da and a same power voltage ELVDD, brightness observed by human eyes is different with different luminous durations, and there will be a certain deviation in chromaticity.

There are mature solutions in relevant technologies to deal with an impact of the gray-scale voltage Da and the power voltage ELVDD. Therefore, based on a same gray-scale, it can be considered that charging current is consistent. Generally, the initial anode reset voltage V0 is supplied internally by the driving chip 20 and is basically not affected by an external input deviation. When a voltage value of the initial power reference voltage ELVSS deviates, the anode charging potential difference (ELVSS+Vth_OLED-V0) changes, the charging time of the charging stage t1 changes, and the luminous duration changes, resulting in a deviation of display brightness and chroma from a commissioning preset value.

Therefore, in the embodiments of the present application, by adding the compensation line 14 in the display device 100, the compensation line 14 can output the anode reset voltage VI that changes synchronously with the initial power reference voltage ELVSS to the first signal transmission line 12, so as to reduce fluctuation amplitude of a voltage difference between the anode A and the cathode B input to each light-emitting device D, and reduce changes of the brightness and chroma of the display screen, improving display quality of the display panel 10 and improve a yield of the product.

In the embodiments of the present application, synchronous change means that a voltage value of the anode reset voltage VI increases with an increase of the voltage value of the initial power reference voltage ELVSS, or the voltage value of the anode reset voltage VI decreases with a decrease of the voltage value of the initial power reference voltage ELVSS. Ideally, an amount of change in a voltage value of the anode reset voltage VI is equal to an amount of change in a voltage value of the initial power reference voltage ELVSS.

In the embodiments of the present application, the pixel driving circuit 101 shown in FIG. 1 is only an example and cannot be understood as a limitation of the present application. For example, the transistors in the embodiments of the present application are all P-type transistors, but each transistor can also be N-type transistors, etc. For another example, the pixel driving circuit 101 can also comprise other types of threshold voltage compensation structures or power voltage ELVDD compensation structures, which are not limited in the present application.

In the embodiments of the present application, the driving chip 20 can be a source driving chip. The source driving chip can be configured to output the gray-scale voltage Da to the pixel driving circuit 101 to drive the light-emitting device D to emit light with corresponding brightness.

In the embodiments of the present application, the display device 100 can further comprise a feedback circuit 30. The feedback circuit 30 comprises an input end c and an output end d. In the display stage, the input end c receives an adjustment voltage Vs. The output end d outputs the anode reset voltage VI that changes synchronously with the initial power reference voltage ELVSS to the first signal transmission line 12. The adjustment voltage Vs is an actual voltage at any transmission position during a transmission of the initial power reference voltage ELVSS to the cathodes B.

In the embodiments of the present application, when a size of the display panel 10 is large and a number of data lines is large, a plurality of driving chips 20 need to be arranged in order to improve the driving ability. Each of the driving chips 20 can output the initial power reference voltage ELVSS to the display panel 10. In order to output a corresponding anode reset voltage VI, the embodiments of the present application can arrange a plurality of feedback circuits 30 correspondingly to the driving chips 20 one by one.

In the embodiments of the present application, the adjustment voltage Vs can be the actual voltage at any transmission position during the transmission of the initial power reference voltage ELVSS to cathodes B. For example, the adjustment voltage Vs can be the initial power reference voltage ELVSS directly output by the driving chip 20. The adjustment voltage Vs can also be the actual voltage of the initial power reference voltage ELVSS at any transmission position in the display panel 10. The present application will be described in detail in the following embodiments and will not be repeated here.

It can be understood that, on the one hand, the initial power reference voltage ELVSS can be generated by an external chip and then input to the driving chip 20, and then processed by the driving chip 20 and output to the display panel 10, while the initial anode reset voltage V0 is usually supplied from the driving chip 20. The initial power reference voltage ELVSS can be affected by external input deviation and change. On the other hand, with an increase of usage time of the display device 100, the driving chip 20 may have problems such as line loss. The voltage value of the initial power reference voltage ELVSS output by the driving chip 20 may fluctuate. If the initial anode reset voltage V0 input to the pixel driving circuit 101 remains the original value, the brightness and chroma of the display screen of the display panel 10 will change, thereby affecting the display quality.

Therefore, please refer to FIG. 4. FIG. 4 is a second schematic structural diagram of a display device provided by the present application. A difference from the display device 100 shown in FIG. 1 is that in the embodiments of the present application, the feedback circuit 30 is arranged inside the driving chip 20. The adjustment voltage Vs can be the initial power reference voltage ELVSS directly output by the driving chip 20. The driving chip 20 outputs the anode reset voltage VI to the display panel 10 according to the initial power reference voltage ELVSS. The output end d is connected with the second terminal b. That is, the initial anode reset voltage V0 output from the second terminal b is the anode reset voltage VI.

The embodiments of the present application directly set the initial power reference voltage ELVSS to the adjustment voltage Vs. The voltage driving chip 20 synchronously adjusts the initial anode reset voltage V0 according to the change of the initial power reference voltage ELVSS. Fundamentally, the voltage difference between the initial power reference voltage ELVSS output to the display panel 10 and the initial anode reset voltage V0 is guaranteed to be stable, and the change of brightness and chroma of the display screen caused by the change of the initial power reference voltage ELVSS output by the driving chip 20 is reduced.

In the embodiments of the present application, the feedback circuit 30 comprises a voltage follower 31. Specifically, as shown in FIG. 5, the voltage follower 31 comprises an input resistor R1 and a feedback resistance R2.

Wherein a positive input end of the voltage follower 31 receives the adjustment voltage Vs, that is, the initial power reference voltage ELVSS. A negative input terminal of the voltage follower 31, one end of the input resistor R1, and one end of the feedback resistance R2 are connected together. Another end of the input resistor R1 is grounded. Another end of the feedback resistor R2 is connected to an output end of the voltage follower 31. The output end of the voltage follower 31 is connected to the second terminal b.

Wherein by setting a resistance ratio of the input resistor R1 and the feedback resistance R2, a ratio of the anode reset voltage VI to the initial power reference voltage ELVSS can be adjusted. When the voltage value of the initial power reference voltage ELVSS changes, an amount of change of the anode reset voltage VI can be adjusted. Thus, variation of the anode charging potential difference (ELVSS+Vth_OLED-V0) caused by the voltage value of initial power reference voltage ELVSS is reduced.

Alternatively, a resistance value of the input resistor R1 and a resistance value of the feedback resistance R2 are equal, that is, magnification of the voltage follower 31 is 1. The voltage value of the initial power reference voltage ELVSS is equal to the voltage value of the anode reset voltage VI. An amount of change in a voltage value of the anode reset voltage VI is completely equal to an amount of change in a voltage value of the initial power reference voltage ELVSS, which completely offsets the change of the anode charging potential difference (ELVSS+Vth_OLED-V0) caused by the change of the voltage value of the initial power reference voltage ELVSS.

In addition, in the related technology, a voltage conversion circuit needs to be arranged in the driving chip 20 to output the anode reset voltage VI. In the embodiments of the present application, the voltage follower 31 is arranged in the feedback circuit 30 to make the anode reset voltage VI output follow the initial power reference voltage ELVSS, which can simplify an internal circuit structure of the driving chip 20 and reduce a size of the driving chip 20.

Of course, in other embodiments of the present application, other detection modules can also be arranged in the feedback circuit 30 to monitor the voltage value of the initial power reference voltage ELVSS output by the driving chip 20 in real time, and then adjust and output the corresponding anode reset voltage VI, the present application is not limited to this.

It can be understood that when the driving chip 20 outputs the initial power reference voltage ELVSS to the display panel 10, due to an influence of RC delay, the longer the transmission distance is, the greater signal loss is in a process of transmitting the initial power reference voltage ELVSS to a corresponding pixel driving circuit 101. A change of the initial power reference voltage ELVSS caused by RC delay will also change the brightness and chroma of the display screen. The further away the pixel driving circuit 101 is from the driving chip 20, the smaller the voltage value of the initial power reference voltage ELVSS received by the pixel driving circuit 101. Therefore, the anode charging potential differences (ELVSS+Vth_OLED-V0) of the pixel driving circuit 101 at different positions are different. Thus, driven by a same gray-scale voltage Da, the luminous brightness and chroma of the light-emitting devices D in different pixel driving circuits 101 are different, affecting the display uniformity.

Therefore, please refer to FIG. 1 and FIG. 6. FIG. 6 is a third schematic structural diagram of the display device provided by the present application. A difference from the display device 100 shown in FIG. 1 is at least that in the embodiments of the present application, the display panel 10 has a first end 10a and a second end 10b arranged corresponding to each other. The driving chip 20 is arranged at the first end 10a. The display device 100 comprises at least one first signal transmission line 12 and at least one second signal transmission line 11. The second signal transmission line 11 is connected to the first terminal a. The second signal transmission line 11 is configured to transmit the initial power reference voltage ELVSS. Both the second signal transmission line 11 and the first signal transmission line 12 extend from the first end 10a to the second end 10b.

Wherein the second signal transmission line 11 is provided with a detection point P. An actual voltage of the initial power reference voltage ELVSS at the detection point P is the adjustment voltage Vs. The first signal transmission line 12 is provided with a compensation point Q corresponding to the detection point P. The output end d is connected with the compensation point Q. That is, the feedback circuit 30 outputs the anode reset voltage VI to the compensation point Q.

Wherein the second signal transmission line 11 and the first signal transmission line 12 are connected to the driving chip 20 through wiring.

It should be noted that the compensation point Q corresponds to the detection point P, which can be considered that the detection point P and the compensation point Q are located in a same horizontal line or in a same area in a direction from the first end 10a to the second end 10b. In order to clearly show a connection relationship between the detection point P and the compensation point Q and the feedback circuit 30, the detection point P and the compensation point Q drawn in FIG. 5 are not located on a same horizontal line, but it cannot be understood as a limitation of the present application.

Specifically, the input end c of the feedback circuit 30 can be connected to the detection point P through a test line 13 to obtain the actual voltage of the initial power reference voltage ELVSS at the detection point P. The output end d of the feedback circuit 30 can be connected to the compensation point Q through the compensation line 14 to output the anode reset voltage VI to the compensation point Q.

The embodiments of the present application arrange the detection point P on the second signal transmission line 11 to obtain the actual voltage value of the initial power reference voltage ELVSS at the detection point P. Taking the actual voltage value of the initial power reference voltage ELVSS at the detection point P as the adjustment voltage Vs, the anode reset voltage VI varying with the initial power reference voltage ELVSS can be obtained. Since the detection point P and the compensation point Q are arranged correspondingly along the direction from the first end 10a to the second end 10b, after the reset voltage VI is output to the compensation point Q, the actual voltage of the initial power reference voltage ELVSS at the detection point P and the anode reset voltage VI at the compensation point Q can be transmitted to the anodes A and cathodes B of the light-emitting devices D in a same area, respectively. Therefore, by compensating the initial anode reset voltage V0, the change of the anode charging potential difference (ELVSS+Vth_OLED-V0) caused by transmission loss of the initial power reference voltage ELVSS can be reduced to prevent the change of brightness and chroma of the display screen.

In an embodiment of the present application, the second signal transmission line 11 and the first signal transmission line 12 are arranged on different layers. The second signal transmission line 11 and the first signal transmission line 12 are overlapped in a direction perpendicular to a light-emitting surface of the display panel 10.

A certain wiring distance is needed to connect the pixel driving circuit 101 with the detection point P and the compensation point Q, thus transmission loss will also occur. In the embodiments of the present application, the second signal transmission line 11 and the first signal transmission line 12 are overlapped, which can ensure that losses of the initial power reference voltage ELVSS and the initial anode reset voltage V0 transmitted to the pixel driving circuit 101 are equal.

Further, the overlapping arrangement of the detection point P and the compensation point Q can ensure that the actual voltage of the initial power reference voltage ELVSS at the detection point P and the anode reset voltage VI at the compensation point Q can be transmitted to a same pixel driving circuit 101, and further reduce the change of the anode charging potential difference (ELVSS+Vth_OLED-V0) of the light-emitting device D in a corresponding pixel driving circuit 101.

Referring to FIG. 5 at a same time, in the embodiments of the present application, the feedback circuit 30 comprises a voltage follower 31. The voltage follower 31 comprises an input resistor R1 and a feedback resistance R2.

A positive input end of the voltage follower 31 receives the adjustment voltage Vs, that is, the actual voltage of the initial power reference voltage ELVSS at the detection point P. A negative input terminal of the voltage follower 31, one end of the input resistor R1, and one end of the feedback resistance R2 are connected together. Another end of the input resistor R1 is grounded. Another end of the feedback resistor R2 is connected to an output end of the voltage follower 31. The output end d is connected with the compensation point Q. That is, the output end of the voltage follower 31 is configured to output the anode reset voltage VI.

Wherein by setting a resistance ratio of the input resistor R1 and the feedback resistance R2, a ratio of the anode reset voltage VI to the initial power reference voltage ELVSS can be adjusted. When the voltage value of the initial power reference voltage ELVSS changes, the amount of change of the anode reset voltage VI can be adjusted. Thus, the variation of the anode charging potential difference (ELVSS+Vth_OLED-V0) caused by the voltage value of initial power reference voltage ELVSS is reduced.

Alternatively, a resistance value of the input resistor R1 and a resistance value of the feedback resistance R2 are equal, that is, magnification of the voltage follower 31 is 1. The voltage value of the initial power reference voltage ELVSS is equal to the voltage value of the anode reset voltage VI. an amount of change in a voltage value of the anode reset voltage VI is completely equal to an amount of change in a voltage value of the initial power reference voltage ELVSS, which completely offsets the change of the anode charging potential difference (ELVSS+Vth_OLED-V0) caused by the change of the voltage value of the initial power reference voltage ELVSS.

Of course, please refer to FIG. 7. FIG. 7 is a schematic structural diagram of a feedback circuit provided by the present application. In the embodiments of the present application, the feedback circuit 30 comprises a first computing unit 32 and a second computing unit 33. The first computing unit 32 is configured to receive the adjustment voltage Vs and the initial power reference voltage ELVSS. The adjustment voltage Vs is the actual voltage of the initial power reference voltage ELVSS at the detection point P. The first computing unit 32 is configured to calculate a difference value Vf between the initial power reference voltage ELVSS and the adjustment voltage Vs. The second computing unit 33 is configured to receive the initial anode reset voltage V0 and the difference value Vf to add the difference Vf. The second computing unit 33 is configured to add the difference value Vf to the initial anode reset voltage V0 to obtain the anode reset voltage VI.

By arranging the first computing unit 32 and the second computing unit 33 in the feedback circuit 30, the embodiments of the present application can calculate the anode reset voltage VI that should be compensated at the corresponding compensation point Q according to the loss transmitted from the initial power reference voltage ELVSS to the detection point P, so as to offset the change of anode charging potential difference (ELVSS+Vth_OLED-V0) caused by the voltage value of the initial power reference voltage ELVSS and prevent the change of display brightness and chroma.

In the embodiments of the present application, a detection point P can be arranged at a position of the second signal transmission line 11 away from the driving chip 20. A plurality of detection points P can also be arranged at intervals on the second signal transmission line 11 to reduce display unevenness caused by RC delay.

Specifically, please refer to FIG. 8. FIG. 8 is a fourth schematic structural diagram of a display device provided by the present application. A difference from the display device 100 shown in FIG. 6 is at least that in the embodiments of the present application, the display panel 10 comprises a display area AA and a non-display area NA. The second signal transmission line 11 and the first signal transmission line 12 are located in the non-display area NA.

Wherein the second signal transmission line 11 is provided with a plurality of detection points P. The first signal transmission line 12 is provided with a plurality of compensation points Q. The detection points P and the compensation points Q are arranged in a one-to-one correspondence. The feedback circuit 30 generates an anode reset voltage VI to a corresponding compensation point Q according to an actual voltage of the initial power reference voltage ELVSS at each detection point P.

Wherein the term “arranged in a one-to-one correspondence” means that a number of the detection points P and a number of the compensation points Q are equal. And along the direction from the first end 10a to the second end 10b, each of the detection points P and a corresponding one of the compensation point Q are located in a same horizontal line or within a same area.

In the embodiments of the present application, a feedback circuit 30 can be arranged corresponding to each of the detection points P. It is also possible to arranged only one feedback circuit 30, as long as a plurality of voltage followers 31 or a plurality of first computing unit 32 and a plurality of second computing unit 33 in the foregoing embodiments are arranged in the feedback circuit 30. There is no specific limitation in the present application. FIG. 8 shows only a connection relationship between one of the detection points P and the feedback circuit 30 to illustrate the embodiments of the present application, but it should not be understood as a limitation of the present application.

From the above analysis, it can be seen that due to the influence of RC delay, the voltage value of the initial power reference voltage ELVSS at the detection point P farthest away from the driving chip 20 is smallest. Therefore, driven by a same gray-scale voltage Da, the luminous brightness and chroma of the light-emitting devices D in different pixel driving circuits 101 are different, affecting the display uniformity. By arranging a plurality of detection points P on each second signal transmission line 11, the embodiments of the present application can eliminate an influence of differences of the initial power reference voltages ELVSS at different positions caused by different RC loading as much as possible.

In addition, the embodiments of the present application can avoid affecting the display of the display panel 10 by arranging the second signal transmission line 11 and the first signal transmission line 12 in the non-display area NA.

Further, in the embodiments of the present application, the display panel 10 comprises two second signal transmission lines 11 and two first signal transmission lines 12. The two second signal transmission lines 11 can be respectively located in the non-display area NA on both sides of the display area AA in the display panel 10. The two first signal transmission lines 12 can be respectively located in the non-display area NA on the both sides of the display area AA in the display panel 10. Each of the second signal transmission line 11 is provided with a plurality of detection points P arranged at equal intervals. The detection points P located on the two second signal transmission lines 11 are arranged axisymmetrically.

That is, the embodiments of the present application arrange the plurality of detection points P symmetrically left and right, which can ensure that a plurality of pixel driving circuits 101 respectively connected with two second signal transmission lines 11 at a same horizontal position in the direction from the first end 10a to the second end 10b can obtain a same compensation.

In addition, in the embodiments of the present application, two second signal transmission lines 11 are arranged in the display panel 10, which can reduce a distance between part of the pixel driving circuits 101 and the second signal transmission line 11, so as to reduce the signal loss. Similarly, same is true for the first signal transmission line 12.

In an embodiment of the present application, please refer to FIG. 9. FIG. 9 is a fifth schematic structural diagram of a display device provided by the present application. The second signal transmission line 11 is provided with M detection points P. The first signal transmission line 12 is provided with M first compensation points Q1 and N second compensation points Q2. Along the direction from the first end 10a to the second end 10b, M detection points P and M first compensation points Q1 are arranged in a one-to-one correspondence. Wherein M is an integer greater than or equal to 2, and N is an integer greater than or equal to 1.

Wherein, at least one of the second compensation points Q2 is arranged between two adjacent first compensation points Q1. The anode reset voltage VI corresponding to each of the second compensation point Q2 is obtained by interpolating the anode reset voltages VI corresponding to two adjacent first compensation points Q1.

By arranging the second compensation point Q2 and interpolating the anode reset voltages VI corresponding to the two adjacent of the first compensation points Q1 to obtain the anode reset voltage VI corresponding to the second compensation point Q2, the embodiments of the present application can simplify a circuit structure of the display device 100 and reduce power consumption of the feedback circuit 30. At a same time, compensation efficiency is improved.

In the embodiments of the present application, the driving chip 20 further comprises a plurality of third terminals. The plurality of third terminals output at least one gray-scale voltage Da to the display panel 10. When the gray-scale voltage Da is less than or equal to a preset voltage, in the display stage, the feedback circuit 30 is in an operating state. The output end d outputs the anode reset voltage VI. The compensation line 14 transmits the anode reset voltage VI that changes synchronously with the initial power supply reference voltage ELVSS to compensate the initial anode reset voltage V0. When the gray-scale voltage Da is greater than the preset voltage, the feedback circuit 30 is in a turned-off state in the display stage. The second terminal b of the driving chip 20 outputs the initial anode reset voltage V0 to the pixel driving circuit 101. No signal is transmitted on the compensation line 14.

Wherein, the preset voltage can be a gray-scale voltage Da corresponding to any low gray-scale. For example, when the pixel data of the display panel 10 is 8 bit, the display panel 10 has 256 gray-scales (0 gray-scale-255 gray-scale). The preset voltage can be a gray-scale voltage Da corresponding to 40 gray-scale or a gray-scale voltage Va corresponding to 60 gray-scale. Specifically, the display brightness and chroma can be set under the influence of the initial power reference voltage ELVSS driven by different gray-scale voltage Da.

For details, please refer to FIGS. 10 and 11. FIG. 10 is a schematic diagram of a relationship between an initial power reference voltage and a color coordinate y provided by the present application. FIG. 11 is a schematic diagram of a relationship between an initial power reference voltage and a luminous brightness provided by the present application.

Wherein test conditions are the initial anode reset voltage V0=3.0V, the initial power reference voltage ELVSS=−3.375V, the display gray-scale is 32 gray-scale, and the display brightness of the display panel 10 is 2nit.

It can be seen from the figures that under a low gray-scale, the gray-scale voltage Da is small, a charging current in the pixel driving circuit 101 is small, and the change of the anode charging potential difference (ELVSS+Vth_OLED-V0) caused by the voltage value of the initial power reference voltage ELVSS has a great impact on the charging time, thus a great impact is had on a luminous brightness Lv and a color coordinate y of the display chroma. In a high gray-scale, the gray-scale voltage Da is large, a charging current in the pixel driving circuit 101 is large, and the change of anode charging potential difference (ELVSS+Vth_OLED-V0) caused by the voltage value of the initial power reference voltage ELVSS has a negligible impact on the charging time, and little impact is had on the luminous brightness Lv and the color coordinate y of the display chroma.

Therefore, in the embodiments of the present application, only when the gray-scale voltage Da is less than or equal to the preset voltage, the feedback circuit 30 outputs the anode reset voltage VI to the anode A of the light-emitting device D according to the adjustment voltage Vs. When the gray-scale voltage Da is greater than the preset voltage, the feedback circuit 30 is in a turned-off state, which can effectively reduce the power consumption.

It should be noted that the above determination action can be performed by the driving chip 20 or by a timing controller that outputs the gray-scale voltage Da to the display panel 10, the present application is not limited to this.

In the embodiments of the present application, the display device 100 further comprises a circuit board (not shown in the figures). The circuit board is connected with the driving chip 20. The feedback circuit 30 can be integrated inside the driving chip 20 or on the circuit board. When the feedback circuit 30 is integrated inside the driving chip 20, the integration of the driving chip 20 can be improved and the signal wiring outside the display device 100 can be reduced. When the feedback circuit 30 is integrated on the circuit board, the size of the driving chip 20 can be improved and reduced, and the power consumption of the driving chip 20 can be reduced.

Specifically, please refer to FIG. 12. FIG. 12 is a sixth schematic structural diagram of a display device provided by the present application. In the embodiments of the present application, the feedback circuit 30 is integrally arranged inside the driving chip 20. The driving chip 20 has a first terminal a, a second terminal b, a feedback terminal e, and a compensation terminal f. The first terminal a outputs the initial power reference voltage ELVSS to the second signal transmission line 11. The second terminal b outputs the initial anode reset voltage V0 to the first signal transmission line 12. The second signal transmission line 11 is provided with a detection point P. The first signal transmission line 12 is provided with a compensation point Q. The feedback terminal e is connected to the detection point P. The compensation terminal f is connected to the compensation point Q through the compensation line 14. The driving chip 20 generates an anode reset voltage VI to the corresponding compensation point Q according to the actual voltage of the initial power reference voltage ELVSS at each detection point P.

Wherein when arranging multiple detection points P and multiple compensation points Q, multiple of the feedback terminal e and the compensation terminals f are also arranged. That is, the detection points P and the feedback terminals e are connected in a one-to-one correspondence. The compensation points Q and the compensation terminals f are connected in a one-to-one correspondence.

It should be noted that when the feedback circuit 30 is integrated and arranged inside the driving chip 20, settings of the second signal transmission line 11, the first signal transmission line 12, the detection point P, and the compensation point Q can refer to the above embodiments and will not be repeated here.

The display device provided in the present application is described in detail above. And in this paper, specific examples are applied to explain the principle and implementation mode of the application. The above embodiments are only examples of the implementation of the present invention. It must be noted that the disclosed embodiments do not limit the scope of the present invention. On the contrary, the modification and equalization of the spirit and scope comprised in the claims are comprised in the scope of the invention.

What is claimed is:

1. A display device, comprising:
a display panel, the display panel comprising a plurality of light-emitting devices;
a driving chip, wherein the driving chip has a first terminal and a second terminal; in a display stage, the first terminal outputs an initial power reference voltage to cathodes of the light-emitting devices, and the second terminal outputs an initial anode reset voltage to anodes of the light-emitting devices;
a first signal transmission line, arranged in the display panel and connected with the second terminal, wherein the first signal transmission line transmits the initial anode reset voltage in the display stage; and
a compensation line, wherein the compensation line is connected to any position of the first signal transmission line; and in the display stage, the compensation line transmits an anode reset voltage that changes synchronously with the initial power reference voltage.

2. The display device according to claim 1, wherein the driving chip comprises a voltage follower, and the voltage follower comprises an input resistor and a feedback resistance;
wherein a positive input end of the voltage follower receives the initial power reference voltage, a negative input end of the voltage follower, one end of the input resistor, and one end of the feedback resistor are connected together, another end of the input resistor is grounded, another end of the feedback resistance is connected with an output end of the voltage follower, and the output end of the voltage follower is connected with the second terminal, the initial anode reset voltage changes synchronously with the initial power reference voltage.

3. The display device according to claim 2, wherein a resistance value of the input resistor and a resistance value of the feedback resistance are equal.

4. The display device according to claim 1, wherein the display panel has a first end and a second end arranged corresponding to each other, the driving chip is arranged at the first end, the display device comprises at least one first signal transmission line and at least one second signal transmission line, and both the first signal transmission line and the second signal transmission line extend from the first end to the second end, the second signal transmission line is connected with the first terminal, and in the display stage, the second signal transmission line transmits the initial power reference voltage;
wherein the driving chip further has a feedback terminal and a compensation terminal, the second signal transmission line is provided with a detection point, the first signal transmission line is provided with a compensation point corresponding to the detection point, the feedback terminal is connected with the detection point, and the compensation terminal is connected with the compensation point through the compensation line.

5. The display device according to claim 4, wherein the first signal transmission line and the second signal transmission line are arranged in different layers, and the first signal transmission line and the second signal transmission line are overlapping in a direction perpendicular to a light-emitting surface of the display panel.

6. The display device according to claim 4, wherein the display panel comprises a display area and a non-display area connected with the display area, and the first signal transmission line and the second signal transmission line are located in the non-display area;
wherein the second signal transmission line is provided with a plurality of detection points, the first signal transmission line is provided with a plurality of compensation points, and the detection points and the compensation points are arranged in a one-to-one correspondence.

7. The display device according to claim 6, wherein the display panel comprises two first signal transmission lines and two second signal transmission lines, the two first signal transmission lines are respectively located in the non-display area on both sides of the display area in the display panel, and the two second signal transmission lines are respectively located in the non-display area on the both sides of the display area in the display panel;
wherein each of the two second transmission lines is provided with the plurality of detection points arranged at equal intervals, and the detection points located on the two second signal transmission lines are arranged axisymmetrically.

8. The display device according to claim 4, wherein the second signal transmission line is provided with M detection points, and the first signal transmission line is provided with M first compensation points and N second compensation points;
along a direction from the first end to the second end, the M detection points and the M first compensation points are arranged in a one-to-one correspondence, wherein M is an integer greater than or equal to 2, and N is an integer greater than or equal to 1;
wherein at least one of the second compensation points is arranged between two adjacent ones of the first compensation points, and an anode reset voltage corresponding to each of the second compensation points is obtained by interpolating anode reset voltages corresponding to two adjacent ones of the first compensation points.

9. The display device according to claim 4, wherein the detection point is located at a position of the second signal transmission line away from the driving chip.

10. The display device according to claim 4, wherein the display device further comprises a test line, and the feedback terminal is connected with the detection point through the test line.

11. The display device according to claim 4, wherein the driving chip comprises at least one voltage follower, and the voltage follower comprises an input resistor and a feedback resistor;
a positive input end of the voltage follower is connected with the detection point; a negative input end of the voltage follower, one end of the input resistor, and one end of the feedback resistance are connected together; another end of the input resistor is grounded; another end of the feedback resistance is connected with an output end of the voltage follower; and the output end of the voltage follower is connected with the compensation point through the compensation line.

12. The display device according to claim 11, wherein a resistance value of the input resistor and a resistance value of the feedback resistance are equal.

13. The display device according to claim 4, wherein the display device further comprises at least one voltage follower, the voltage follower is arranged outside the driving chip, and the voltage follower comprises an input resistor and a feedback resistance;
a positive input end of the voltage follower is connected with the detection point; a negative input end of the voltage follower, one end of the input resistor, and one end of the feedback resistance are connected together; another end of the input resistor is grounded; another end of the feedback resistance is connected with an output end of the voltage follower; and the output end of the voltage follower is connected with the compensation point through the compensation line.

14. The display device according to claim 13, wherein a resistance value of the input resistor and a resistance value of the feedback resistance are equal.

15. The display device according to claim 13, wherein the display device further comprises a circuit board, the circuit board is connected with the driving chip, and the voltage follower is integrally arranged on the circuit board.

16. The display device according to claim 4, wherein the display device further comprises a first computing unit and a second computing unit, the first computing unit is connected with the detection point and receives the initial power reference voltage, the first computing unit calculates a difference value between the initial power reference voltage and a detection point voltage, the second computing unit receives the initial anode reset voltage and the difference value, and the anode reset voltage is obtained by adding the difference value to the initial anode reset voltage.

17. The display device according to claim 16, wherein the first computing unit and the second computing unit are arranged inside the driving chip.

18. The display device according to claim 1, wherein the driving chip further comprises a plurality of third terminals, and in the display stage, the plurality of third terminals output at least one gray-scale voltage to the display panel;
when the gray-scale voltage is less than or equal to a preset voltage, the compensation line transmits the anode reset voltage that changes synchronously with the initial power reference voltage.

19. The display device according to claim 1, wherein an amount of change in a voltage value of the anode reset voltage is equal to an amount of change in a voltage value of the initial power reference voltage.

20. A display device, comprising:
a display panel, the display panel comprising a plurality of light-emitting devices;
a driving chip, wherein the driving chip has a first terminal and a second terminal; in a display stage, the first terminal outputs an initial power reference voltage to cathodes of the light-emitting devices, and the second terminal outputs an initial anode reset voltage to anodes of the light-emitting devices;
a first signal transmission line, arranged in the display panel and connected with the second terminal, wherein the first signal transmission line transmits the initial anode reset voltage in the display stage, and the first signal transmission line is provided with a compensation point;
a second signal transmission line, arranged in the display panel and connected with the first terminal; wherein in the display stage, the second signal transmission line transmits the initial power reference voltage, and the second signal transmission line is provided with a detection point corresponding to the compensation point;
a test line, the test line connected with the detection point;
a compensation line, wherein the compensation line is connected with the compensation point, and in the display stage, the compensation line transmits an anode reset voltage that changes synchronously with the initial power reference voltage; and
a voltage follower, the voltage follower comprising an input resistor and a feedback resistor; a positive input end of the voltage follower is connected with the detection point through the test line; a negative input end of the voltage follower, one end of the input resistor, and one end of the feedback resistance are connected together; another end of the input resistor is grounded; another end of the feedback resistance is connected with an output end of the voltage follower; and the output end of the voltage follower is connected with the compensation point through the compensation line.
